(19) United States
(12) Patent Application Publication
(10) Pub. No.: US 2004/0030590 A1
(43) Pub. Date: Feb. 12, 2004

(54) Total integrated performance system and method

(76) Inventors: Coalen L. Swan, Midlothian, TX (US); Kirby R. Scott, Rowlett, TX (US); Gregory L. Peterson, DeSoto, TX (US)

Correspondence Address: Robert J. Ward, Hunton & Williams LLP, Energy Plaza, 30th Floor, 1601 Bryan Street, Dallas, TX, 75201-3402, US

(21) Appl. No.: 10/637,069

(22) Filed: Aug. 5, 2003

Related U.S. Application Data
(60) Provisional application No. 60/401,144, filed on Aug. 5, 2002.

(51) Int. Cl. G06F 17/60

(52) U.S. Cl. 705/7

(57) ABSTRACT

A total integrated performance system for managing projects is provided. The system comprises a database for maintaining project data associated with a project that includes data representative of actual project costs, budgeted project costs, and commitment costs associated with the project. The system further comprises a processing component operably connected to the database and adapted to compare th actual project costs to the budgeted project costs using the project data of the database and to determine a total cost to terminate the project, the total cost of terminating the project based at least in part on the actual project costs and the commitment costs of the project. The system is also adapted to generate a report providing the comparison of the actual project costs to the budgeted and to provide the total cost to terminate the project. A project management method and computer readable medium are also provided.

### CROSS-REFERENCE TO RELATED APPLICATIONS

The present invention claims benefit of U.S. Provisional Application No. 60/401,144, filed Aug. 5, 2002, the entirety of which is incorporated by reference herein.

### FIELD OF THE INVENTION

This invention relates in general to the field of project management and more particularly, but not by way of limitation, to a total integrated performance system and method for managing development of a project.

### BACKGROUND OF THE INVENTION

Project management systems are useful for managing the development of projects. Project management systems, however, suffer from many shortcomings and deficiencies that make if difficult if not impossible to efficiently and accurately track and manage project tasks and costs. For at least this reason, a need exists for an improved project management system and method for managing project development.

### SUMMARY OF THE INVENTION

The present invention provides a total integrated performance system, hereinafter “system,” for managing projects. According to one aspect, the system includes a first and second database, the first database to maintain data identifying actual project costs and being associated with an accounting system that maintains business accounting information. The second database maintains data identifying commitment project costs.

The system further includes a processing component and a reporting component, the processing component is adapted to read the first and second databases and identify actual project costs related to the commitment project costs. The reporting component is adapted to generate a report identifying the actual project costs related to the commitment project costs. The reporting component further is adapted to sum the actual project costs and commitments to determine the total project costs. In one aspect, the commitment project costs are maintained in the first database and the second database is unnecessary.

According to one aspect, budgeted data is maintained by the first database, the budgeted data identifying the initial costs estimated to complete the project. Projected data is maintained by the second database, the projected data identifying an estimated cost to complete the project as the project progresses. The reporting component is adapted to include the budgeted data and projected data in the calculations.

According to one aspect, the system also includes a database to maintain data identifying actual project management costs, data identifying budgeted project management costs, and a plurality of tasks defining the project. The system includes a processing component and a reporting component, the processing component is adapted to compare the actual project management costs related to the budgeted project management costs.

The processing component further is adapted to identify changes to the plurality of tasks defining the project. The reporting component is adapted to generate a report identifying the actual project management costs related to the budgeted project management costs. The reporting component further is adapted to generate a report identifying changes to the plurality of tasks defining the project.

One advantage provided by the present invention is the comparison capability of the actual versus the budgeted project management costs by identifying the actual and budgeted project management costs and reporting the actual and project management costs. Another advantage of the present invention is the ability to monitor and control changes to the scope of the project by identifying changes to the plurality of tasks and reporting these changes.

According to another aspect, the system of the present invention further provides for reconciling project management costs and such that the database further comprises an accounting database and a project management database. The accounting database maintains data identifying actual project management costs and the project management database maintains data identifying budgeted project management costs. In one aspect, the accounting database is an organization's central accounting system records and in other aspects, the accounting database may be a copy of the relevant portions of the organization's accounting system records, while yet in other aspects, the accounting database may be a real-time analyze or merging of the organization's central accounting system records with the system of the present invention.

Reconciliation of the actual and budgeted project management costs is a significant advantages of the present invention since a project management system with an independent accounting or cost budget will rarely, if ever, be completely accurate when compared to the actual expenditures of a project. Reconciliation of these costs provides an accurate and timely analysis of the project costs.

In yet another aspect, the system of the present invention provides a database to maintain data identifying a project. The project data comprising a plurality of tasks defining the project and a charter authorizing completion of the project based upon the tasks defining the project. The system further provided with a processing component is adapted to periodically scan the database and track the plurality of tasks of the project and determine changes to the plurality of tasks of the project.

The system including a reporting component is adapted to generate a report identifying changes to the plurality of tasks of the project. Change control and tracking is another advantage of the present invention and useful for identifying changes to the project and the project scope since the project's inception or original charter authorizing the project.

In one aspect, the processing component is further is adapted to periodically scan the database to track the plurality of tasks of the project and wherein the report is further is adapted to track the plurality of tasks of the project in comparison to new or modified task. According to one aspect, the project is further defined as having a scope and the charter relates to an authorization of the scope of the project and wherein the subsequently identified task represents an alteration to the scope of the project such that the report of the reporting component is further defined as tracking changes to the scope of the project.

According to yet another aspect, the present invention provides a project management system including a cost component related to costs of a project, the cost component including an actual portion, a budgeted portion and a commitments portion. The project management system further includes a scheduling component and a reporting component. The scheduling component related to the schedule of the project and the reporting component provided to track the schedule of the project and the costs of the project, the reporting component reporting the cost of the project at a period of the schedule.

According to one aspect, the reporting component is adapted to report the costs of the project at the period of the schedule as a comparison of the actual portion of the costs with the budgeted portion of the costs. While in yet another aspect, the actual portion of the costs and the commitment portion of the costs is a total cost of the project and wherein the reporting component is adapted to report the actual expenses the project as a comparison of the budgeted portion of the costs. In another aspect, the actual portion of the costs and the commitment portion of the costs define a total cost of the project and wherein the reporting component is adapted to report the actual expenses of the project in a project termination report.

According to yet another aspect, the present invention provides a system for reconciling project management costs between budgeted costs and actual costs. The system includes a database to maintain data identifying actual costs and data identifying commitment costs associated with a project. The system includes a processing component is adapted to periodically scan the database and identify commitment costs related to the actual costs of the project. The system also includes a reporting component is adapted to generate a report identifying the actual costs of the project related to the commitment costs of the project.

In one aspect, the actual costs are electronically obtained from an independent accounting system. In another aspect, the database further comprises a data identifying budgeted costs associated with the project, the processing component is further is adapted to periodically scan the database and identify projected costs associated with the project. In yet another aspect, the reporting component may operably generate a report identifying a total cost to terminate the project.

In this aspect, the total cost to terminate the project is calculated by adding the actual costs of the project to the commitment costs of the project.

In other aspects, the reporting component is adapted to generate a report identifying a total cost to complete the project. In this aspect, the total cost to complete the project are calculated by adding the actual costs of the project, the commitment costs of the project and the projected costs of the project. The reporting component further is adapted to analyze the budgeted costs in comparison with the sum of the actual costs, commitments, and projected costs of the project.

According to yet another aspect of the present invention, a system for authorizing a project is provided. The system includes a database an authorization component, an updating component, an authorizing component and a tracking component. The database maintains data identifying the project, the database includes an approver data identifying approvers with authority to authorize the project and a charter identifying the scope of the project, the charter including a current project scope. The database also includes an authorization data identifying whether the approver has authorized the current project scope.

The authorization component communicates the charter to the approver identified by the approver data and further is adapted to receive the authorization data from the approver. The updating component allows modifications to the charter and authorization data. The tracking component tracks changes to the charter and determine whether the current project scope of the charter has been authorized based upon the authorization data.

Authorization of a project is another significant advantage of the present invention since frequently the scope of projects change and additional authorization is necessary. It will be appreciated that while the authorization system may be utilized with the project management system according to one aspect, in other aspects the authorization system may be utilized by any system where tracking authorization to any scope changes is useful.

According to one aspect, the present invention provides a method of project management including creating a charter for a project including providing a purpose, an objective, and a scope of a project and determining an objective or deliverable for the project. The method includes determining whether the project is related to other projects in the project management and determining a responsible party for the project. The method includes providing a plurality of tasks including a completion date of each of the plurality of the tasks and the project.

The method includes determining the days off schedule and determining the costs associated with the project, while in other aspects, the costs associated with each task are determined. The costs include actual, budgeted and commitments. According to one aspect, the commitments are defined as all legal costs associated with the project that have not been passed through the business' or organization's accounting system, such as general ledger. Commitments may include non-purchase ordered legal obligations, credit card purchases, time-tickets and perhaps certain invoices. In one aspect, the actual costs may be obtained by merging, integrating or interfacing with an separate accounting system or database and obtaining actual costs associated with the budgeted costs. According to one aspect, the method includes reconciling the budgeted costs with the actual costs, and generating a report identifying the budgeted in comparison to the actual costs.

In one aspect, the method may include identifying and reporting on change control of the project wherein each of the plurality of tasks defining the project are monitored for subsequent or modified tasks. The method may include tracking risk events and the mitigation of these risk events, sharing documents and tracking lessons for reuse in future project. In yet another aspect, the method may include a work order component is adapted to authorize, schedule and track the costs of work orders.

Other objects, features, and advantages of the present invention will be apparent to those skilled in the art from the following detailed description when read in conjunction with the accompanying drawings.

### BRIEF DESCRIPTION OF THE DRAWINGS

The present invention can be understood more completely by reading the following Detailed Description of the Invention, in conjunction with the accompanying drawings, in which:

FIG. 1 is a block diagram illustrating an exemplary project management system in accordance with one aspect of the present invention.

FIG. 1A is a block diagram illustrating one aspect of an exemplary chartering system for authorizing projects in accordance with another aspect of the present invention.

FIG. 2 is a flow chart illustrating an exemplary method of operation of the project management system of FIG. 1 in accordance with another aspect of the present invention.

FIG. 3 is a block diagram illustrating an exemplary project management report including performance measures of a project in accordance with another aspect of the present invention.

### DETAILED DESCRIPTION OF THE INVENTION

The following description is intended to convey a thorough understanding of the invention by providing a number of specific embodiments and details related to an integrated project management system. It is understood, however, that the invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

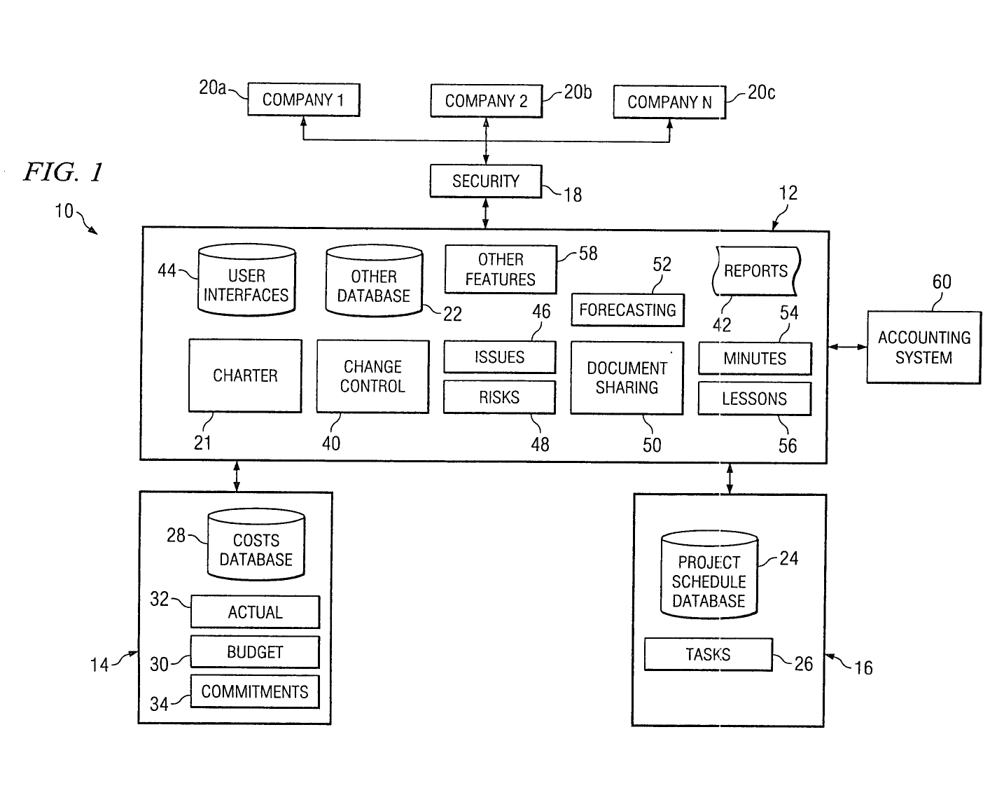

Referring now to FIG. 1, a total integrated performance system for project management is illustrated in accordance with one aspect of the present invention. The total integrated performance system, herein referred to as system 10, may be implemented as software, hardware, firmware, or a combination thereof. To illustrate, the system 10 may be beneficially implemented on a computer system such as a single personal computer (PC), workstation or server operably connected to one or more computer networks. Software portions of the system 10 may be developed utilizing any number of readily available application development languages such as Java script, SQL, Visual Basic or other well-known tools, and implemented on a variety of platforms such as a Microsoft Windows NT® operating system. The system 10 may be a software application implemented where portions of one or more databases accessed by the system 10 are located on a first computer and the application implementing the system 10 may be on the same computer or on a second computer system.

Accordingly, in at least one embodiment, some or all of the components of the system 10 and the various methods for its use are implemented in whole or in part as a computer readable medium comprising executable instructions. The executable instructions are adapted to manipulate at least one processor to perform the various processes described herein.

In the exemplary illustration of FIG. 1, the system 10 includes a main module 12 in bidirectional communication with a cost component 14 and a project scheduling component 16. The main module 12 may be provided with a network interface (not shown) to a network accessible by one or more users, such as companies 20a-20c. The main module 12 further may be provided a security layer 18, which may be a firewall or network security applications such as provided in various network or workstation operating systems. The security layer 18 acts as the gatekeeper to restrict user access to the main module 12. The security layer 18 may include procedures for logging the users or companies 20a-20c onto the system 10 for information and authentication purposes. The security layer 18 may also be provided with multiple levels of access to the system 10 such that a number of users may have access to a certain project, but not access to others, however, only certain users may have access to, for example, scheduling and accounting features, and other high security level elements within the project.

The companies 20a-20c may represent users having direct access to the system 10 via a network terminal or work station or may represent Internet appliances or computers that access the system 10 via the Internet or other network. In other aspects the companies 20a-20c may be unrelated/autonomous organizations utilizing the system 10 to obtain the advantages and benefits of the system 10 under use or license agreements to access the system 10, for example, over the Internet, wide area network (WAN), local area network (LAN) or other intra-organizational networks.

In at least one embodiment, the system 10 has a number of innovative capabilities for project management. One such capability includes a charter 21 representing a business case for a project to be managed by the system 10. The charter 21 allows a user to create the charter 21 for a project and designate a responsible party or parties for approval of the project, where the approval represents the initial preauthorization stages of the project to be managed by the system 10. The charter 21 generally may include a purpose, objective and a scope of the project and also may include one or more assumptions to be made for the project. Creating the charter 21 may include identifying the one or more approvers needed to approve the project, and the system 10 may provide functions such as automatically emailing notifications of the creation of new charters 20 to the approvers for approval or rejection. The approvers may authorize or reject the charter 21 and project either by email or by connecting to the system 10. Once the charter 21 has been submitted for approval, the system 10 may provide a project status indicator (not shown) to identify whether the project has been approved.

Referring now to FIG. 1A, an exemplary chartering system 200 for authorizing projects or project elements is illustrated in accordance with at least one aspect of the present invention. The chartering system 200 preferably includes a database 202 to maintain data identifying the project. The database 202 may include approver data 204 for identifying approvers with the authority to authorize the project and a charter 206 identifying the scope of the project. The charter 206 also may include a current project scope 208. The database 202 further may include authorization data 210 for identifying whether the approver associated with the approver data 204 has authorized the current project scope 208.

The chartering system 200 further includes an authorization component 212 adapted to communicate a representation of the charter 206 to the approver identified by the approver data 204 and further configured to receive the authorization data 210 from the approver.

The chartering system 200 also includes an updating component 214 and a tracking component 216. The updating component 214 allows modifications to the charter 206 and authorization data 210. The tracking component 216 is configured to track changes to the charter 206 and determine whether the current project scope 208 of the charter 206 has been authorized based upon the authorization data 210.

The chartering system 200 further may be provided with an indicator (not shown) illustrating the current authorization status of the current project scope 208 of the charter 206. In this manner, once the current project scope 208 has been modified, the authorization data 210 may be reset to a “not authorized” status until the approver indicated by the approver data 204 authorizes the modification or change to the current project scope 208.

Referring again to FIG. 1, once the charter 21 has been approved, information such as deliverables, including the title, description and timeframe of the deliverables, such as the product, process, development or purpose of the project, may be provided to the system 10 and may be stored, for example, in other databases 22 utilized by the system 10. The project schedule may then be prepared utilizing the project scheduling component 16, which may include a project schedule database 24 for maintaining data identifying tasks 26 necessary to complete the project.

The task 26 may be a breakdown of project work, which may include high-level descriptions of broad or general milestones that must be accomplished to successfully complete the project. The task 26 may also be used to breakdown the project into a more elemental form where work-orders, labor units and equipment or supplies utilized for the project are individually identified as tasks 26.

Yet another advantage of the present invention is that the system 10 provides for associating a number of features with the tasks 26. Documents, work-orders and tracking changes or modifications to the tasks 26 are examples of such associated information maintained by the system 10. The association of such information may be accomplished by, for example, embedding or linking the associated features or data to the tasks 26 or may be accomplished by an identifying project number, code or task number for association purposes. In addition, a variety of other methods of enabling this association exist that will readily suggest themselves to one of ordinary skill in the art using the guidelines provided herein.

It will be appreciated that additional information useful for the current project or the future project may also be stored in the project schedule database 24 or other databases 22. This additional information may include, but is not limited to, information regarding whether the project is related to other projects, such as by the type of project the individuals or companies involved in the project, and information regarding the project number, purpose, responsibility or objectives. Information about the tasks 26 maintained in the project schedule database 24 may also include information regarding various portions of the project, such as the percentage of work represented by the task, scheduling for the dates to begin, end and the duration of the task, estimated completion dates and relationships to other tasks for the project as well as database fields for when the task 26 is actually completed.

By providing scheduling information related to the tasks 26, it may be readily ascertained whether the project is on schedule or has “slipped” off schedule, information that is useful for the project manager to quickly identify and then determine the effects on a larger scale of such slippage. One embodiment of the present invention provides the ability to determine both the slippage of the tasks 26 and what effect their slippage will have on the project by, for example, summing the total slippage of all of the tasks 26. It will be appreciated that the tasks 26 typically have interdependencies such that delays on one task 26 may have a significant impact on the schedules of other dependent tasks 26 and the project as a whole. This is another advantage of the present invention in that by reallocating slippage of tasks 26 and the effect on the project as a whole through reporting such as via reports 42 or user interfaces 44, the status from a scheduling standpoint of the current project may be readily identified.

In one aspect, the scheduling portion of the system 10, such as the project scheduling component 16, may be provided as a backend, or the backend may be supported by any of a variety of commercially available project management applications, such as, for example, Microsoft® Project or Primavera® and the system 10 may interface and communicate with the these applications. In this manner, the user interfaces 44 may be simplified so that the users of system 10 generally do not need any project scheduling knowledge or experience of, for example, Critical Path Methodology or a complex scheduling system, such as Microsoft® Project. The user merely inputs the schedule data for processing by the backend of the project scheduling component 16. This is another advantage of the present invention as it removes the necessity of highly skilled project schedulers and requires data entry users. The system 10, according to one aspect, automates complex jobs such as tying the costs from the financial and accounting system to the schedule.

Another innovative aspect of the system 10 of the present invention is that the cost component 14 preferably resides in a substantially parallel relationship to the project scheduling component 16. In this manner, the cost associated with each of the project elements or tasks 26 are maintained in the cost component 14 of the system 10 in a cost database 28. The costs may include budgeted costs 30 which are related to the estimated costs of a project, an element or portion of the project, breakdowns of the project, such as by a task 26 at the time the task is initially identified with the project.

It will be appreciated that while the costs database 28 is exemplarily illustrated as a single database or system in FIG. 1, in other aspects, the costs database 28 may be one or more databases where the actual costs 32 are maintained in a first database and commitments 34 are maintained in a second database.

The budgeted costs 30 may be, or include, projected or forecast costs and may be updated or modified as the project progresses and a more accurate forecast or projection of cost becomes available or apparent. In one aspect, budgeted costs 30 represent both the initial budget estimate of the project and a periodically updated projected cost to complete the project. Actual costs 32 are related to the actual expenses paid related to the task 26. The budgeted costs 30 represent an estimate of the cost of the tasks 26, while the actual costs 32 represent the actual expenditure related to the particular task 26 and that the actual costs 32 and the budgeted costs 30 related to a particular task 26 generally are not identical. This provides a significant advantage because the budgeted costs 30 of a project frequently are significantly lower than the actual costs 32 to complete the project.

According to one aspect, the budgeted costs 32 may be provided in a first database (not shown) along with the actual costs 32, and the system 10 may be further provided with projected or forecast costs provided with the commitment 34 in a second database (not shown). In this aspect, the forecast or projected data is similar to the budgeted costs 30 at the beginning of the project. Once the project begins, however, the forecast or projected costs may be updated to more accurately reflect the estimate to complete the project than was originally estimated. The budgeted costs 30 generally will remain unchanged. In other aspects, all the data may be maintained in databases of the system 10 or maintained in a third party database and dynamically retrieved by the system 10. The terms project costs and project management costs preferably refer to any costs associated with a project.

The present invention provides an innovative way of obtaining, identifying, and providing this useful cost information by coupling the system 10 to an independent accounting system (not shown). Organizations typically maintain an accounting system for managing all of the financial aspects of a business. The present invention 10, such as by association with a project number or other identifier, interfaces, integrates, or merges with the accounting system 60. The system 10 may then query the accounting system 60, such as through database searches, or other means well known in the art, to obtain the actual costs 32 logged in the accounting system that are associated with the budgeted costs 30 in the system 10.

The functionality provided by the system 10 by identifying not only the budgeted cost 30, but by interfacing with the actual accounting system 60 to obtain the actual cost 32 provides the capability to reconcile the project costs or tasks costs which provide the user of the system 10, for project management purposes, valuable information with respect to the current status of the project, budgeting accuracy, cost control and a myriad of other project management controls from a cost standpoint. Furthermore, this reconciliation may be done against not only actual costs 32 that are paid, such as a financial transaction where payment is actually made, but also against invoices received that are actually due and have not yet been paid, such as by a purchase order invoice, as well as against a non-purchase order invoice.

The system 10, according to one aspect, may electronically interface with the independent accounting system 60. This may be accomplished in a number of manners including real-time access to the actual data in the accounting system 60 or by making backups or mirror images of the accounting data for duplication and insertion into the costs 28 database of the cost component 14 of the system 10. In other aspects this may be accomplished in a batch process, while yet in other aspects the independent accounting system 60 may be a parallel system developed for interfacing with the system 10, or vice-versa, or intended to be compatible or maintained as a module accessible by the system 10. Additional ways of accomplishing this may utilize techniques that are well known in the art including real time system, function, library calls to the accounting system requesting as return information the desired actual cost 32.

The electronic retrieval of the actual costs 32 is often advantageous as it saves data entry time and expense and reduces the significant data entry errors that often occur where otherwise all the actual cost 32 would need to be manually entered into the system 10.

The terms “independent accounting system” or “accounting system” preferably are intended to refer to accounting systems that generally do not depend on the system 10 to be useable or executable, although it may share libraries, functions, and routines useful to the system 10 as well. Although in other aspects, the accounting system 60 may be integrated with system 10 or vice-versa.

The cost database 28 further includes commitments 34 which are legal obligations that the project has incurred which may or may not be budgeted costs 30, but have not yet become an actual cost 32. Examples of commitments 34 may include agreements to pay for work, products to be delivered and paid for upon delivery, legal obligations that have not yet been invoiced, or any number of similar obligations which have not yet become actual costs 32 and may or may not have been budgeted costs 30. This often is advantageous since the budgeted costs 30 may reflect an estimate of the project and the actual cost 32 may illustrate the current financial expenses incurred or owed related to a project, but these amounts alone may not reflect the true financial picture of the project at a given time. By including commitments 34 into the cost component 14 of the system 10, the true picture of the financial status or project can be easily ascertained by including the actual cost 32 and the commitments 34 for a project.

This is particularly useful where a project is to be terminated prior to completion and it is imperative to ascertain the complete costs to an organization for terminating the project, which would necessarily include the actual cost 32 that have been paid and the commitments 34 that will be due once all the invoicing and financial processing has been completed. Furthermore, without identifying commitments 34 by the cost component 14, it is possible that one would obtain an inaccurate picture of the current financial status of a project.

This is particularly true where the budgeted cost 30 indicates an unusually high cost and the actual cost 32 indicates an unusually low cost, thereby giving the impression that the project has not incurred significant expenses to date. In actuality, however, a number of commitments 34 may have been made and will be due in the very near future and have a significant impact on the actual costs 32 bringing them more into alignment or possibly over the budgeted cost 30. These tools provide a project manager significant capabilities with respect to planning and decision making on projects.

The system 10 further may include a plurality of useful features and functions for managing projects including, for example, a change control 40 for monitoring changes in the scope of a project. In one aspect, the change control 40 monitors changes to the scope 208 of the charter 206 while in other aspects, the change control 40 may be configured to monitor changes to any of the tasks 26 defining the project to be managed by the system 10. For example, when a user initially sets up a project and outlines the scope, objectives and the plurality of tasks 26 that define the project, it will be appreciated that these tasks 26 may expand, be changed, or new tasks 26 may be required to complete the project. Frequently, these changes affect the overall scope and objective of the project and it is useful for the project manager or responsible individuals to be aware of these changes.

According to one aspect, the system 10 may be adapted to periodically scan the costs database 28 and sum the actual costs 32 and the commitments 34 to ascertain the total cost to terminate or stop the project prior to completion. Such information may be presented by the user interfaces 44, for example, on a computer screen for viewing, or reported by the reports 42, such as by printed hard copies. In addition, the system 10 may be further configured to periodically scan the costs database 28 and by summing the actual costs 32 and commitments 34 together with the budgeted costs 30, which may be forecast, projected or budgeted, whether initially or modified thereafter, provide the total cost of the project through completion. This provides yet another advantage of the present invention since the change through the user interfaces 44, to have information displayed in a useful manner reporting on such things as modifications to the tasks 26. The change control 40 may be affected in a number of manners including keeping a log of any modifications to the tasks 26, keeping a backup of the original tasks 26 and from time-to-time comparing the original tasks 26 to the current information in the project schedule database 24 related to each of the tasks 26 of the project. Another means of implementing the change control 40 is to create a change control file that may be maintained each time tasks 26 are modified. Although the foregoing are exemplary implementing of the change control 40, it will be appreciated that the functionality of the change control 40 may be accomplished using any number of well-known programming techniques using the guidelines provided herein.

The system 10 further includes an issues feature that is useful for assigning responsibility, actions or activities to an event that has caused an unscheduled event or occurrence that requires attention to continue with the project. Issues 46 may also include portions of tasks 26 which were unable to be completed due to, for example, mechanical breakdown of equipment utilized to complete the task 26.

An additional feature of the system 10 is a risk feature (risks 48), which provides the system 10 with the capability to maintain, retrieve and identify events that could potentially jeopardize the successful completion of the project. Examples of risks 48 may include labor strikes or shortages, weather events and other unexpected or less likely events that could reasonably occur and impact the project. The issues 46 and risks 48 capabilities of the system 10 are additional advantages of the present invention in that they allow, via reports 42 and user interfaces 44, project managers to readily identify and manage projects by providing them with access to critical information useful for these purposes.

Another feature of the present invention is that the system 10 provides a document sharing component 50 that is particularly useful when a number of individuals are simultaneously working on a project and need access to, for example, project-related documents. Sharing documents in such an environment, such as a work group or work room speeds dissemination of the information contained in such documents, as well as promotes more rapid feedback with respect to their comments, and provides another advantage of the present invention.

The present invention provides a forecasting component 52 that allows the budgeted cost 30 to be summed and presented, in reports 42 or via the user interfaces 44, for presentation of, for example, complete project costs, scheduling, as well as breaking down the project into certain elements or groupings for projection and forecasting purposes.

Frequently, projects require meetings that must be documented and the system 10 of the present invention provides for maintaining document meetings with a minutes component 54. The minutes component 54 allows for storing and retrieving meeting documentation by users with the appropriate security access so that decisions about particular aspects of the project can be readily viewed with respect to the information that was decided, the responsible parties, timing and scheduling.

Another advantage of the present invention is a lessons component 56 that provides an organized technique for maintaining critical, yet reusable, information that can be shared to continually refine and improve on projects in the future. Such information may include, for example, specific venders or contractors that were particularly efficient or inefficient, strategies, planning, and other information that was successful or unsuccessful which may be useful to future project managers and is available for not only the current project members but also may be accessible to other users of the system 10 on other, perhaps unrelated, projects. The other features component 58 provides additional functionality for the system 10. An example of this additional functionality includes providing scheduling, cost tracking capability for work-orders and other activities.

According to another aspect, the present invention provides for accessing the system 10 via a network (e.g., the Internet) wherein the costs component 14 and costs database 28, and/or the project scheduling component 16 and the project scheduling database 24 reside on the trusted side of the security 18. Any manner of configurations, locations, topologies, including the handling and location of the processing components, data storage components and databases are within the spirit and scope of the present invention.

The system 10 may be adapted to communicate with, for example, the costs database 28 by an ODBC, or Open Database Connectivity, call to a shared network drive on an intra-company network system, in other aspects, such data may be obtained via the Internet via copying or transferring files for local use or transferring on the necessary portion of data as needed. Such as in one aspect, the system 10 may create copies of all or certain portions of the accounting system files, in other aspects, only the necessary, fractional portions of data may be returned by these function, object or program calls.

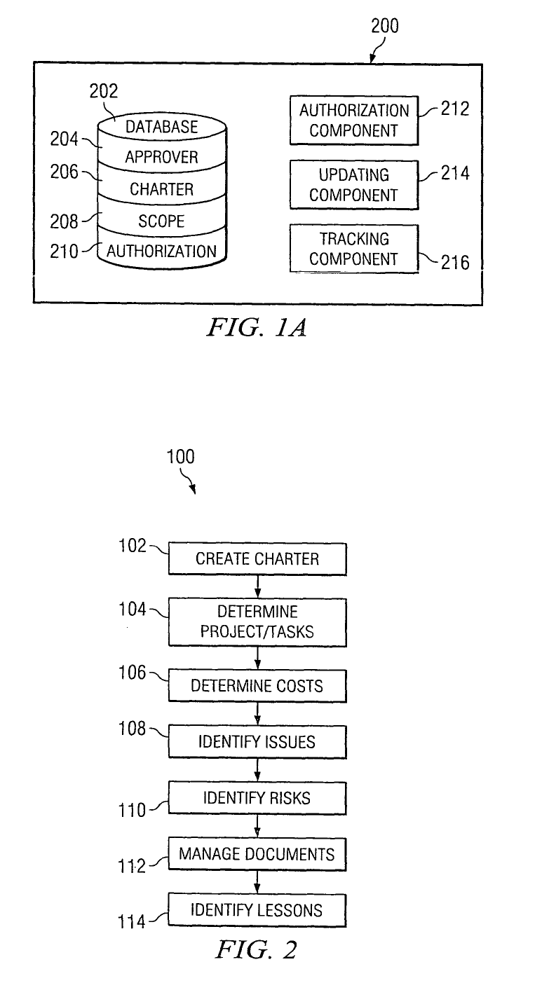

Referring now to FIG. 2, an exemplary method 100 for project management is illustrated in accordance with one aspect of the present invention. The method 100 initiates at step 102, whereby the charter 21 (FIG. 1) is created. As noted previously, the charter 21 preferably outlines the scope and objectives of a project.

At step 104, elements of the project are identified. The project elements then may be broken down into tasks 26 (FIG. 1) that are scheduled and the associated budgeted costs 30 (FIG. 1) for each of the tasks 26 may be estimated. As noted above, the tasks 26 may be monitored by the change control 40 (FIG. 1) to identify changes or modifications in the scope or tasks 26 of the project for project management purposes.

At step 106, the costs of each of the tasks 26 may be reconciled with actual costs 32 and commitments 34 (FIG. 1) so that the system 10 may usefully provide the users with an accurate and up-to-date picture of the cost of the project. As previously discussed, determining the cost may include interfacing with business accounting systems (e.g., accounting system 60, FIG. 1) that are ordinarily utilized for primarily accounting purposes.

At step 108, issues 46 that may arise during the project and alter the task 26 or acquire additional scheduling to complete the tasks 26 for the project are identified by the system 10. At a step 110, the risks 48 are identified so that individuals involved in the project can readily identify events that could potentially jeopardize the successful outcome of the project. At step 112, various documents may be managed, whereby the management of the documents may include, for example, sharing files via a workroom, such as by the Internet and intranet or computer network system. Other documents that may be shared include project meeting minutes and other documents for identifying decisions with regard to the project. At step 114, lessons 56 learned during the project may be identified so that the project process may be improved upon in the future.

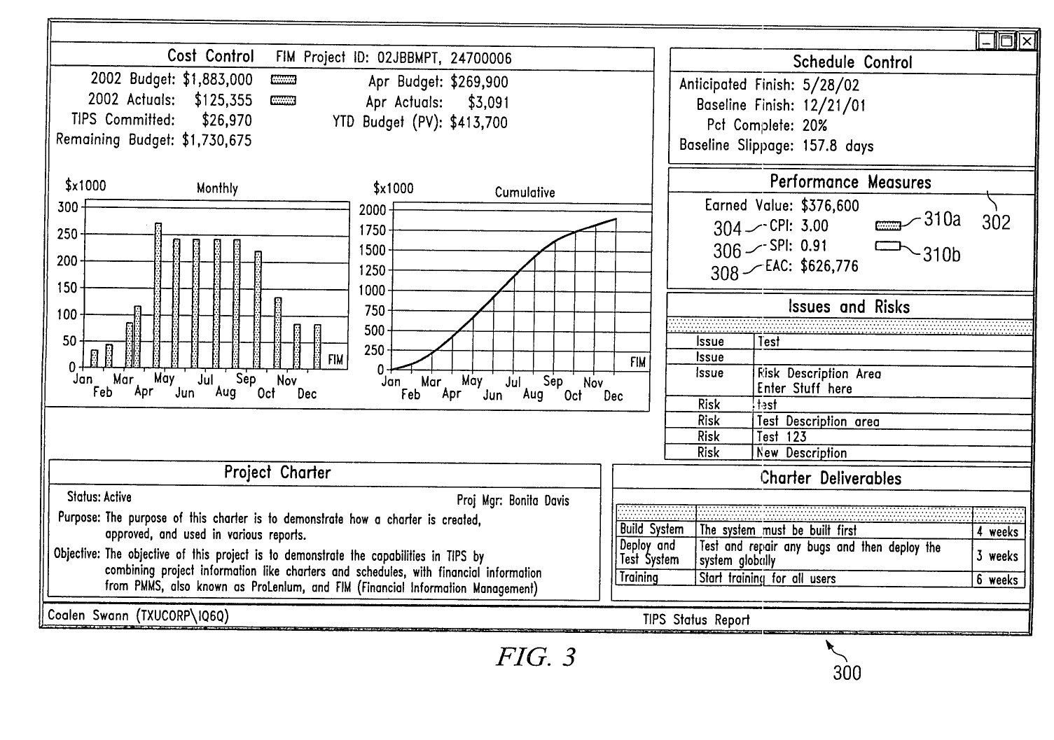

Referring now to FIG. 3, an exemplary report 300 provided by the reports 42 of the system 10 is illustrated in accordance with one aspect of the present invention. For ease of illustration, the following exemplary report 300 is discussed in the context of the project management standards provided by the Project Management Institute (PMI), which are frequently used as a guideline for management of a wide variety of project types. The system 10, according to one aspect, incorporates certain of these PMI standards and provides a useful way of processing and presenting this information in a format more useable for those involved in project management.

To illustrate, the exemplary report 300 may provide useful PMI information such as cost performance index (CPI) 304 and schedule performance index (SPI) 306. The CPI 304 and SPI 306 are commonly-used indicia useful for determining the earned value, which is the cost up to the current point for a project compared to the percentage planned to be complete for these costs. The earned value then may be compared to the budgeted costs 30 for the project to determine whether, for the cost up to the current point, the project is as far along as originally anticipated.

One useful feature of the present invention is the color-coded bars graphs 310a and 310b corresponding to the CPI 304 and SPI 306, respectively. The bar graphs 310a and 310b may be adapted to display a color associated with the progress of the project for the respective indicia. For example, display of the color green could represent that the project is on schedule with respect to the time or budget, the color yellow could represent a cautionary indicator that the project is slipping with respect to time or budget, while the color red could indicate these indices are considerably inconsistent with the budgeted time and/or costs. The color-coded bar graphs 310a and 310b therefore may provide the user of the system 10 with a quick and easy reference to the current status of the actual costs 32, which may or may not include commitments 34, of the project related to the budgeted costs 32.

The exemplary report 300 also may provide a calculation of the estimated cost to complete a project, referred to herein as the EAC 308. The EAC 308 may be derived by determining the current cost and amount of the project completed carrying this cost factor to one hundred percent complete. The system 10 may be adapted to automatically calculate these formulas quickly, thereby timely providing data useful to project management.

Thus, it is apparent that there has been provided, in accordance with the present invention, a project management system, method and computer readable medium that satisfy one or more of the advantages set forth above.

In accordance with one aspect of the present invention, the system comprises at least one database for maintaining project data associated with the project, the project data including data representative of actual project costs, data representative of budgeted project costs, and data representative of commitment costs associated with the project. The system further comprises a processing component operably connected to the at least one database and adapted to compare the actual project costs to the budgeted project costs using the project data of the at least one database and determine a total cost to terminate the project using the project data of the at least one database, the total cost of terminating the project based at least in part on the actual project costs and the commitment costs of the project. The processing component may be adapted to determine the total cost to terminate the project based at least in part on a sum of the actual project costs and the commitment costs of the project. The system also comprises a reporting component operably connected to the processing component and adapted to generate a report providing the comparison of the actual project costs to the budgeted project costs and generate a report providing the total cost of terminating the project.

The processing component may be further adapted to determine a total cost to complete the project based at least in part on the actual project costs, the budgeted project costs and the commitment costs of the project and the reporting component may be further adapted to generate a report providing the total cost of completing the project. In this aspect, the project data of the at least one database further includes data representative of a plurality of the tasks defining the project, at least one of the plurality of tasks being uncompleted. The processing component therefore may be adapted to determine the total cost to complete the project based at least in part on a sum of the actual project costs, the commitment costs of the project and a portion of the budgeted costs associated with the at least one uncompleted task.

The project data of at least one database further may include data representative of a plurality of tasks defining the project. In this aspect, the processing component is further adapted to identify changes to the plurality of tasks based at least in part on the project data of the at least one database and the reporting component may be further adapted to generate a report identifying the changes to the plurality of tasks.

The data representing the actual costs may be electronically obtained from an independent accounting system.

In one aspect, the project data of at least one database further includes approver data identifying at least one approver entity with authority to authorize the project, charter data identifying a scope of the project, the charter data including data representative of a current project scope, and authorization data indicating whether the current project scope is authorized by an approver entity. In this aspect, the system may further comprise an authorization component operably connected to the at least one database and adapted to communicate a representation of the current project scope to at least one approver entity identified by the approver data, receive an authorization indicating the current project scope is authorized from the at least one approver entity and modify the authorization data to indicate that the current project scope is authorized.

In another aspect, the project data of the at least one database further includes data representative of at least one task identified subsequent to an authorization of the project and the processing component is further adapted to identify one or more changes to the plurality of tasks as a result of the subsequently identified task using the project data of the at least one database, determine a change in a scope of the project based at least in part on the one or more changes and determine whether the change in the scope of the project requires authorization. The report component may be further adapted to generate a report indicating a need for authorization of the project when the change in the scope of the project requires authorization.

In accordance with another aspect of the present invention, the method provided by the present invention comprises the step of maintaining at least one database having project data associated with the project. The project data includes data representative of actual project costs, data representative of budgeted project costs and data representative of commitment costs associated with the project. The method further comprises the steps of comparing the actual project costs to the budgeted project costs using the project data of the at least one database, determining a total cost to terminate the project using the project data of the at least one database, the total cost of terminating the project based at least in part on the actual project costs and the commitment costs of the project, generating a report providing the comparison of the actual project costs to the budgeted project costs, and generating a report providing the total cost of terminating the project. In one aspect, the step of determining the total cost to terminate the project includes summing the actual project costs and the commitment costs of the project.

In one aspect, the method further comprises the steps of determining a total cost to complete the project based at least in part on the actual project costs, the budgeted project costs and the commitment costs of the project and generating a report providing the total cost of completing the project. The project data of the at least one database further includes data representative of a plurality of the tasks defining the project, at least one of the plurality of tasks being uncompleted and the step of determining the total cost to complete the project includes summing the actual project costs, the commitment costs of the project and a portion of the budgeted costs associated with the at least one uncompleted task.

In another aspect, the project data of the at least one database further includes data representative of a plurality of tasks defining the project and the method further comprises the steps of identifying changes to the plurality of tasks based at least in part on the project data of the at least one database and generating a report identifying the changes to the plurality of tasks.

In another aspect of the present invention, the project data of the at least one database includes approver data identifying at least one approver entity with authority to authorize the project, charter data identifying a scope of the project, the charter data including data representative of a current project scope and authorization data indicating whether the current project scope is authorized by an approver entity. The method therefore further comprises the steps of communicating a representation of the current project scope to at least one approver entity identified by the approver data, receiving an authorization indicating the current project scope is authorized from the at least one approver entity and modifying the authorization data to indicate that the current project scope is authorized.

In accordance with yet another aspect of the present invention, project data of the at least one database further includes data representative of at least one task identified subsequent to an authorization of the project and the method further comprises the steps of identifying one or more changes to the plurality of tasks as a result of the subsequently identified task using the project data of the at least one database, determining a change in a scope of the project based at least in part on the one or more changes, determining whether the change in the scope of the project requires authorization and generating a report indicating a need for authorization of the project when the change in the scope of the project requires authorization.

The methods and systems described herein may be implemented as a computer readable medium. The computer readable medium includes executable instructions adapted to manipulate at least one processor to perform the processes described herein. In accordance with one aspect of the present invention, a computer readable medium comprising a set of executable instructions is provided, wherein the executable instructions are adapted to manipulate at least one processor to maintain at least one database having project data associated with the project, the project data including data representative of actual project costs, data representative of budgeted project costs, and data representative of commitment costs associated with the project. The executable instructions are further adapted to manipulate the at least one processor to compare the actual projects costs to the budgeted project costs using the project data of the at least one database, determine a total cost to terminate the project using the project data of the at least one database, the total cost of terminating the project based at least in part on the actual project costs and the commitment costs of the project, generate a report providing the comparison of the actual project costs to the budgeted project costs, and generate a report providing the total cost of terminating the project. The executable instructions may be further adapted to manipulate at least one processor to perform additional processes and techniques described above.

Although the preferred embodiment has been described in detail, it should be understood that various changes, substitutions, and alterations can be made herein without departing from the spirit or the scope of the present invention, even if all of the advantages identified above are not present. For example, the various elements or components may be combined or integrated in another system or certain features may not be implemented.

In addition, the techniques, systems, sub-systems, and methods described and illustrated in the preferred embodiment as discrete or separate may be combined or integrated with other systems, modules, techniques, or methods without departing from the scope of the present invention. Other items shown as directly coupled to each other may be coupled through some other interface or device, such that the items may no longer be considered directly coupled to each other but may still be in communication with one another. Other examples of changes, substitutions, and alterations are readily ascertainable by one skilled in the art and could be made without departing from the spirit and scope of the present invention.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

What is claimed is:

1. A system for managing a project, the system comprising:
at least one database for maintaining project data associated with the project, the project data including:
data representative of actual project costs;
data representative of budgeted project costs; and
data representative of commitment costs associated with the project;
a processing component operably connected to the at least one database and adapted to:
compare the actual project costs to the budgeted project costs using the project data of the at least one database; and
determine a total cost to terminate the project using the project data of the at least one database, the total cost of terminating the project based at least in part on the actual project costs and the commitment costs of the project;
a reporting component operably connected to the processing component and adapted to:
generate a report providing the comparison of the actual project costs to the budgeted project costs; and
generate a report providing the total cost of terminating the project.

2. The system of claim 1, wherein the processing component is adapted to determine the total cost to terminate the project based at least in part on a sum of the actual project costs and the commitment costs of the project.

3. The system of claim 1, wherein the processing component is further adapted to determine a total cost to complete the project based at least in part on the actual project costs, the budgeted project costs and the commitment costs of the project.

4. The system of claim 3; wherein the reporting component is further adapted to generate a report providing the total cost of completing the project.

5. The system of claim 3, wherein the project data of the at least one database further includes data representative of a plurality of the tasks defining the project, at least one of the plurality of tasks being uncompleted.

6. The system of claim 5, wherein the processing component is adapted to determine the total cost to complete the project based at least in part on a sum of the actual project costs, the commitment costs of the project and a portion of the budgeted costs associated with the at least one uncompleted task.

7. The system of claim 1, wherein the project data of at least one database further includes data representative of a plurality of tasks defining the project.

8. The system of claim 7, wherein the processing component is further adapted to identify changes to the plurality of tasks based at least in part on the project data of the at least one database.

9. The system of claim 8, wherein the reporting component is further adapted to generate a report identifying the changes to the plurality of tasks.

10. The system of claim 1, wherein the data representing the actual costs is electronically obtained from an independent accounting system.

11. The system of claim 1, wherein the project data of at least one database further includes:
approver data identifying at least one approver entity with authority to authorize the project;
charter data identifying a scope of the project, the charter data including data representative of a current project scope; and
authorization data indicating whether the current project scope is authorized by an approver entity.

12. The system of claim 11, further comprising an authorization component operably connected to the at least one database and adapted to:
communicate a representation of the current project scope to at least one approver entity identified by the approver data;
receive an authorization indicating the current project scope is authorized from the at least one approver entity; and
modify the authorization data to indicate that the current project scope is authorized.

13. The system of claim 1, wherein:
the project data of the at least one database further includes data representative of at least one task identified subsequent to an authorization of the project; and
the processing component is further adapted to:
identify one or more changes to the plurality of tasks as a result of the subsequently identified task using the project data of the at least one database;
determine a change in a scope of the project based at least in part on the one or more changes;
determine whether the change in the scope of the project requires authorization; and
the report component is further adapted to generate a report indicating a need for authorization of the project when the change in the scope of the project requires authorization.

14. A method for managing a project, the method comprising the steps of:
maintaining at least one database having project data associated with the project, the project data including:
data representative of actual project costs;
data representative of budgeted project costs; and
data representative of commitment costs associated with the project;
comparing the actual project costs to the budgeted project costs using the project data of the at least one database;
determining a total cost to terminate the project using the project data of the at least one database, the total cost of terminating the project based at least in part on the actual project costs and the commitment costs of the project;
generating a report providing the comparison of the actual project costs to the budgeted project costs; and
generating a report providing the total cost of terminating the project.

15. The method of claim 14, wherein step of determining the total cost to terminate the project includes summing the actual project costs and the commitment costs of the project.

16. The method of claim 14, further comprising the step of determining a total cost to complete the project based at least in part on the actual project costs, the budgeted project costs and the commitment costs of the project.

17. The method of claim 16, further comprising the step of generating a report providing the total cost of completing the project.

18. The method of claim 16, wherein the project data of the at least one database further includes data representative of a plurality of the tasks defining being uncompleted.

19. The method of claim 18, wherein the step of determining the total cost to complete the project includes summing the actual project costs, the commitment costs of the project and a portion of the budgeted costs associated with the at least one uncompleted task.

20. The method of claim 14, wherein the project data of the at least one database further includes data representative of a plurality of tasks defining the project.

21. The method of claim 20, further comprising the step of identifying changes to the plurality of tasks based at least in part on the project data of the at least one database.

22. The method of claim 21, further comprising the step of generating a report identifying the changes to the plurality of tasks.

23. The method of claim 14, further comprising the step of electronically obtaining the data representative of the actual costs from an independent accounting system.

24. The method of claim 14, wherein the project data of the at least one database includes:
approver data identifying at least one approver entity with authority to authorize the project;
charter data identifying a scope of the project, the current project scope; and
authorization data indicating whether the current project scope is authorized by an approver entity.

25. The method of claim 24, further comprising the steps of:
communicating a representation of the current project scope to at least one approver entity identified by the approver data;
receiving an authorization indicating the current project scope is authorized from the at least one approver entity; and
modifying the authorization data to indicate that the current project scope is authorized.

26. The method of claim 14, wherein the project data of the at least one database further includes data representative of at least one task identified subsequent to an authorization of the project.

27. The method of claim 26, further comprising the steps of:
identifying one or more changes to the plurality of tasks as a result of the subsequently identified task using the project data of the at least one database;
determining a change in a scope of the project based at least in part on the one or more changes;
determining whether the change in the scope of the project requires authorization; and
generating a report indicating a need for authorization of the project when the change in the scope of the project requires authorization.

28. A computer readable medium, the computer readable medium comprising a set of executable instructions adapted to manipulate at least one processor to:
maintain at least one database having project data associated with the project, the project data including:
data representative of actual project costs;
data representative of budgeted project costs; and
data representative of commitment costs associated with the project;
compare the actual project costs to the budgeted project costs using the project data of the at least one database;
determine a total cost to terminate the project using the project data of the at least one database, the total cost of terminating the project based at least in part on the actual project costs and the commitment costs of the project;
generate a report providing the comparison of the actual project costs to the budgeted project costs; and
generate a report providing the total cost of terminating the project.

29. The computer readable medium of claim 28, wherein the executable instructions adapted to manipulate the at least one processor to determine the total cost to terminate the project include executable instructions adapted to manipulate the at least one processor to sum the actual project costs and the commitment costs of the project.

30. The computer readable medium of claim 28, further comprising executable instructions adapted to manipulate the at least one processor to determine a total cost to complete the project based at least in part on the actual project costs, the budgeted project costs and the commitment costs of the project.

31. The computer readable medium of claim 30, further comprising executable instructions adapted to manipulate the at least one processor to generate a report providing the total cost of completing the project.

32. The computer readable medium of claim 30, wherein project data of the at least one database further includes data representative of a plurality of the tasks defining the project, at least one of the plurality of tasks being uncompleted.

33. The computer readable medium of claim 32, wherein the executable instructions adapted to manipulate the at least one processor to determine the total cost to complete the project include executable instructions adapted to manipulate the at least one processor to sum the actual project costs, the commitment costs of the project and a portion of the budgeted costs associated with the at least one uncompleted task.

34. The computer readable medium of claim 28, wherein project data of the at least one database further includes data representative of a plurality of tasks defining the project.

35. The computer readable medium of claim 34, further comprising executable instructions adapted to manipulate the at least one processor to identify changes to the plurality of tasks based at least in part on the project data of the at least one database.

36. The computer readable medium of claim 35, further comprising executable instructions adapted to manipulate the at least one processor to generate a report identifying the changes to the plurality of tasks.

37. The computer readable medium of claim 28, further comprising executable instructions adapted to manipulate the at least one processor to electronically obtain the data representative of the actual costs from an independent accounting system.

38. The computer readable medium of claim 28, wherein the project data of the at least one database further includes:
approver data identifying at least one approver entity with authority to authorize the project;
charter data identifying a scope of the project, the charter data including data representative of a current project scope; and
authorization data indicating whether the current project scope is authorized by an approver entity.

39. The computer readable medium of claim 38, further comprising executable instructions adapted to manipulate the at least one processor to:
communicate a representation of the charter data to at least one approver entity identified by the approver data;
receive an authorization indicating the current project scope is authorized from the at least one approver entity; and
modify the authorization data to indicate that the current project scope is authorized.

40. The computer readable medium of claim 28, wherein the project data of the at least one database further includes data representative of at least one task identified subsequent to an authorization of the project.

41. The computer readable medium of claim 40, further comprising executable instructions adapted to manipulate the at least one processor to:
identify one or more changes to the plurality of tasks as a result of the subsequently identified task using the project data of the at least one database;
determine a change in a scope of the project based at least in part on the one or more changes;
determine whether the change in the scope of the project requires authorization; and
generate a report indicating a need for authorization of the project when the change in the scope of the project requires authorization.

42. A project management system for tracking changes to a scope of a project resulting at least in part from at least one task necessary to complete the project identified subsequent to an authorization of the project, the project management system comprising:
at least one database for maintaining project data associated with the project, the project data including:
data representative of a plurality of tasks defining the project;
charter data indicating an authorization of the project; and
data representative of the at least one subsequently identified task;
a processing component operably connected to the at least one database and adapted to:
identify one or more changes to the plurality of tasks as a result of the subsequently identified task using the project data of the at least one database; and
determine a change in the scope of the project based at least in part on the one or more changes; and
determine whether the change in the scope of the project requires authorization;
a report component operably connected to the processing component and adapted to generate a report indicating a need for authorization of the project when the change in the scope of the project requires authorization.

43. A method for tracking changes to a scope of a project resulting at least in part from at least task necessary to complete the project identified subsequent to an authorization of the project, the method comprising the steps of:
maintaining at least one database of project data associated with the project, the project data including:
data representative of a plurality of tasks defining the project;
charter data indicating an authorization of the project; and
data representative of the at least one subsequently identified task;
identifying one or more changes to the plurality of tasks as a result of the subsequently identified task using the project data of the at least one database;
determining a change in the scope of the project based at least in part on the one or more changes;
determining whether the change in the scope of the project requires authorization; and
generating a report indicating a need for authorization of the project when the change in the scope of the project requires authorization.

44. A project management system comprising:
a cost component representing project costs, the project costs including actual project costs, budgeted project costs and commitment costs related to the project;
a scheduling component representing a schedule of the project; and
a reporting component operably connected to the cost component and the scheduling component and adapted to report a cost of the project at a given point in the schedule using the cost component and the scheduling component.

45. A project management method comprising:
maintaining a first database including data related to project costs, the project costs including actual project costs, budgeted project costs and commitment costs related to the project;
maintaining a second database including data related to a schedule of the project; and
reporting a cost of the project at a given point in the schedule using the project data of the first and second databases.
